(19) United States
(12) Patent Application Publication
(10) Pub. No.: US 2014/0025730 A1
(43) Pub. Date: Jan. 23, 2014

(54) MANAGING CONCURRENT CONVERSATIONS OVER A COMMUNICATIONS LINK BETWEEN A CLIENT COMPUTER AND A SERVER COMPUTER

(71) Applicant: International Business Machines Corporation, Armonk, NY (US)

(72) Inventors: GERALD M.W. ALLEN, EASTLEIGH (GB); MICHAEL D. BROOKS, ROWNHAMS (GB)

(21) Appl. No.: 13/930,208

(22) Filed: Jun. 28, 2013

(30) Foreign Application Priority Data
Jul. 20, 2012 (GB) 1212873.2

(51) Int. Cl. H04L 29/06

(52) U.S. Cl. CPC H04L 67/42
USPC 709/203

(57) ABSTRACT

A method, system and/or computer program manages a maximum permissible number of concurrent conversations over a communications link between a client computer and a server computer. State information includes an indication as to whether the most recent message sent is the final message in the conversation. When a client computer requests to start a new conversation, the server computer starts the conversation if the maximum number of conversations will not be exceeded. If the maximum number will be exceeded, the server computer checks the state information to find a conversation in which the most recent message sent is the final message in the conversation. If such a conversation cannot be found, the server computer does not start the new conversation. If such a conversation can be found, the server computer queues the message from a client computer to start a new conversation.

This application is based on and claims the benefit of priority from Great Britain (UK) Patent Application 1212873.2, filed on Jul. 20, 2012, and herein incorporated by reference in its entirety.

### BACKGROUND

The present invention relates to managing concurrent conversations over a communications link between a client computer and a server computer, and in particular to managing such concurrent conversations where the communications link has a maximum permissible number of concurrent communications.

A typical computer acting as a server is required to tolerate arrival of messages from a client at the pre-defined legitimate capacity limit and continue to serve such requests. The computer is typically also required to detect circumstances where this limit is exceeded and to take action to prevent the condition from persisting.

### SUMMARY

A method, system and/or computer program manages a maximum permissible number of concurrent conversations over a communications link between a client computer and a server computer. State information includes an indication as to whether the most recent message sent is the final message in the conversation. When a client computer requests to start a new conversation, the server computer starts the conversation if the maximum number of conversations will not be exceeded. If the maximum number will be exceeded, the server computer checks the state information to find a conversation in which the most recent message sent is the final message in the conversation. If such a conversation cannot be found, the server computer does not start the new conversation. If such a conversation can be found, the server computer queues the message from a client computer to start a new conversation.

### BRIEF DESCRIPTION OF THE SEVERAL VIEWS OF THE DRAWINGS

Embodiments of the present invention will now be described in more detail, by way of example only, with reference to the accompanying drawings, in which:

FIG. 1 shows a client computer linked to a server computer via a communications link;

FIG. 2 shows the computers of FIG. 1 with two client tasks having just terminated and their conversations being terminated;

FIG. 3 shows the computers of FIG. 2 with two client tasks in the process of starting new conversations;

FIG. 4 show state information maintained during the management of concurrent conversations between the computers of FIG. 1;

FIG. 5 shows a flow diagram of an embodiment of the present invention in which resources are freed and state updated when a final message is sent; and

FIGS. 6 and 7 show a flow diagram of an embodiment of the present invention for managing concurrent conversations between the computers of FIG. 1.

### DETAILED DESCRIPTION

In one embodiment of the present invention, both a client computer and a server computer have a maximum number of concurrent conversations which they are configured to process. In certain scenarios without the present invention, the computer acting as a server cannot distinguish between a case where messages arrive at a rate which reaches the legitimate capacity limit and the case where messages arrive at a rate that exceeds this limit.

If a server computer is approaching the limit of its processing capacity, it may send the final message of a conversation to the client computer and not have enough processing capacity to update its state information for the terminating conversation before a message from the client computer for a new conversation arrives. Under these circumstances the server computer may regard the arrival of a message for a new conversation to be an attempt to exceed the maximum number of concurrent conversations.

From the viewpoint of the server computer, this situation has the same characteristics as those caused by a client computer which has inadvertently (or deliberately) exceeded the concurrent conversation limit. If this is allowed to persist without the present invention, the server computer may become overloaded and unable to respond to messages which are associated with active conversations.

As a result of these characteristics, without the present invention the server computer cannot distinguish between a legitimate peak in the number of requests by the client computer to start a conversation and an inadvertent attempt by a client computer to overload the server computer.

Presently disclosed prior art teaches a system and method to enhance performance of a server by taking advantage of the half-duplex nature of many HTTP requests. Upon receipt of an HTTP Get resource request, a single send and disconnect IRP is generated. The semantics of the send and disconnect IRP completion recognises the half-duplex nature of the transaction by indicating a graceful close of the TCP/IP connection. The server FIN message to the client may also be included in the last data frame transmitted from the server.

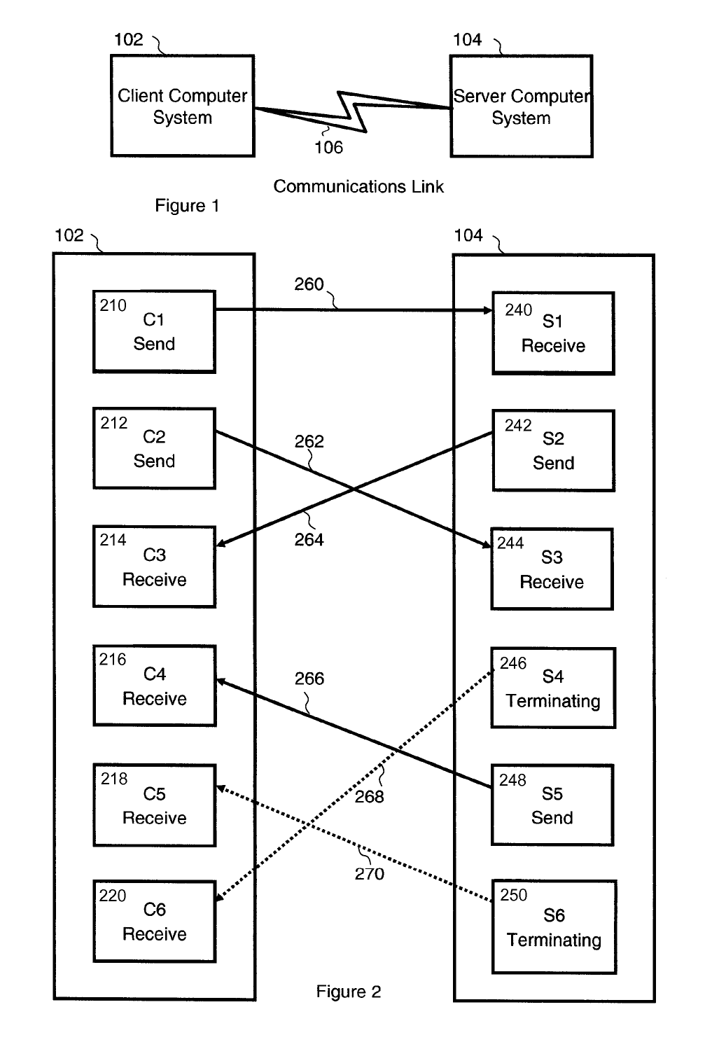

Referring now to the figures, and particularly to FIG. 1, two computers 102, 104 may exchange messages using a communication link 106. One computer has the role of a client computer 102 and the other the role of a server computer 104. Both computers can execute a sequence of instructions to complete a work objective and such a single sequence of instructions is referred to as a task. Both computers have the capability to execute multiple tasks in parallel. Tasks which execute in the client computer 102 will be referred to as client tasks and those which execute in the server computer 104 will be referred to as server tasks.

A sequence of messages which a single client task exchanges with a single server task will be referred to as a conversation. A conversation begins with the first message sent by a client task and a conversation ends with the final message sent by a server task. The communication link 106 has the characteristic that it can be shared by more than one conversation concurrently. However, both the client computer 102 and the server computer 104 have a maximum number of concurrent conversations which they are be configured to process over the communications link 106. The maximum number of concurrent conversations is the same in both computers over the communications link 106.

A problem that can arise is when a computer acting as a server computer 104 cannot distinguish between a first case where messages arrive from a client computer 102 over the communication link 106 at a rate which reaches the legitimate capacity limit and a second case where messages arrive at such a rate that exceeds this limit.

A communication link 106 may employ a half-duplex mode of operation. A half-duplex mode of operation ensures that once a message is sent, control then passes to the recipient task at the other end of the communication link 106. This is repeated with control passing to and from the tasks at each end of the communication link 106 until the conversation ends.

Each computer 102, 104 maintains state information with respect to its view of a conversation. For example, when a server computer 104 has sent a message to the client computer 102, the server computer 104 records that it has done so and expects a reply message from the client computer 102. This is true when the message sent is not the final message in the conversation. Once the final message has been sent, a subsequent message is not expected to be received for that conversation. A conversation is classed as active after the first message is sent and before the final message been sent.

The server computer 104 should not have more active conversations than the client computer 102. If the server computer 104 receives a message from the client computer 102 which starts a new conversation and the state information recorded by the server computer 104 indicates that it already has the maximum number of active conversations, it is expected to send a message to the client computer 102 to inform it that the maximum number of concurrent conversations has been exceeded.

As a result the server computer 104 incurs an additional processing load when a message arrives from a client computer 102 and the maximum number of concurrent conversations is exceeded. There is a finite limit to the processing load capacity of a server computer 104. Therefore when it sends a message to inform the client computer 102 that the maximum number of concurrent conversations has been exceeded this utilises processing capacity which would otherwise to available to update state information for a terminating conversation.

If a server computer 104 is approaching the limit of its processing capacity, it may send the final message of a conversation to the client computer 102 and not have enough processing capacity to update its state information for the terminating conversation before a message for a new conversation arrives. Under these circumstances the server computer 104 may regard the arrival of a message for a new conversation to be an attempt to exceed the maximum number of concurrent conversations. The client computer 102 regards the sending of a message for a new conversation to be within the maximum number of concurrent conversations because it regards the terminating conversation as being terminated. It has received a final message of the conversation from the server computer 104 and it is unaware that the server computer 104 has not yet updated its state information for the terminating conversation.

From the viewpoint of the server computer 104, this situation has the same characteristics as those caused by a client computer 102 which has inadvertently (or deliberately) exceeded the concurrent conversation limit. If this is allowed to persist the server computer 104 may become overloaded and unable to respond to messages which are associated with active conversations.

As a result of these characteristics, the server computer 104 cannot distinguish between a legitimate peak in the number of requests by the client computer 102 to start a conversation and an inadvertent (or deliberate) attempt by a client computer 102 to overload the server computer system.

In an embodiment of the present invention, a server computer 104 distinguishes between active conversations and conversations that are terminating by whether their final message has been transmitted. In addition, a server computer 104 also has the ability to assign a single, new conversation to a terminating conversation at the time when a message arrives for a new conversation, even though the terminating conversation has not yet been completely terminated. If, however, a message for a new conversation arrives, the maximum number of concurrent conversations has been reached and there is no terminating conversation, this condition is treated by the server computer 104 as an error.

FIG. 2 shows a client computer 102 and a server computer 104 which communicate over a communications link (106 in FIG. 1). In the exemplary embodiment of FIG. 2, the communications link supports a maximum of six concurrent conversations. Six client tasks 210-220 are shown together with six server tasks 240-250.

Four client tasks 210-216 have on-going conversations, and are shown as C1 to C4 in FIG. 2 with their messages shown in solid lines. Client task C1 210 has sent a message 260 to Server task S1 240 and is awaiting a reply. Client task C2 212 has sent a message 262 to Server task S3 244 and is awaiting a reply. Client task C3 214 has received a message 264 from Server task S2 242 and is waiting to send a reply. Client task C4 216 has received a message 266 from Server task S5 248 and is waiting to send a reply.

Two client tasks 218, 220 have just terminated and are shown as C5 and C6 in FIG. 2 with their messages shown in dot dash lines. Client task C5 218 has received a final message 270 from Server task S6 250. From the viewpoint of the Client task C5 218, the final message has been received from the Server task S6 250 and the conversation is terminated. From the viewpoint of the Server task S6 250, it is busy carrying out other processing duties and has not yet freed up resources associated with the conversation and so does not yet regard the conversation as terminated. Similarly, Client task C6 220 has received a final message 268 from Server task S4 246. From the viewpoint of the client task C6 220, the final message has been received from the Server task S4 246 and the conversation is terminated. From the viewpoint of the Server task S4 246, it is busy carrying out other processing duties and has not yet freed up resources associated with the conversation and so does not yet regard the conversation as terminated.

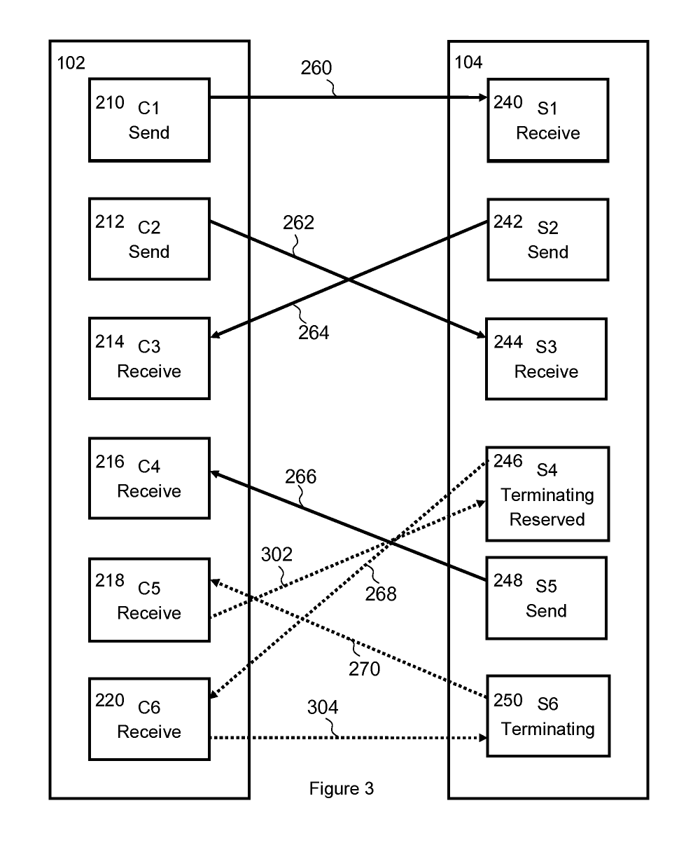

Referring to FIG. 3, two new tasks C5 218 and C6 220 are in the process of starting new conversations. The server computer 104 is busy and has not yet terminated the two conversations 268, 270 for server tasks S4 246 and S6 250 which have sent their final messages back to the client computer 102. The new client task C5 218 has successfully sent a message 302 shown in dot dot dash lines to the server computer 104. In the server computer 104 a new conversation is now reserved for use by the client computer 102 once termination processing has completed for server task S4 246. From the viewpoint of the client computer 102, the previous conversation between server task S4 246 and client C6 220 has completed and so the starting of a new conversation between client task C5 218 and server task S4 246 will not exceed the maximum limit for the number of concurrent conversations over the communications link 106. From the viewpoint of the server, “reserving” the server task S4 246 for use by the new conversation also means that the maximum limit for the number of concurrent conversations over the communications link 106 will not be exceeded as it knows that the conversation between client task C6 220 and server task S4 246 is terminating.

Client task C6 220 has also just started a new conversation by sending a message 304 shown in dot dot dash lines. When the message 304 arrives at the server S6 250, it will be treated by the server S6 250 as “reserving” the server task S6 250 for use by a new conversation. Reservation for this new conversation means that the maximum limit for the number of concurrent conversations over the communications link 106 will not be exceeded as it knows that the conversation between client task C5 218 and server task S6 250 is terminating.

A client computer 102 may erroneously exceed the limit of the number of concurrent conversations which the connection to the server computer 104 has been configured to support and flood the server computer 104 with work, thereby preventing it from operating normally. The server computer 104 can recognise that the request for a new conversation has exceeded the maximum number of concurrent conversations, and so can distinguish between a highly responsive client computer 102 and one that has operated erroneously by exceeding the maximum limit of concurrent conversations. As a result of this, the server computer 104 is able to deal appropriately with each of these two conditions by either queuing legitimate inbound messages for new conversations or processing an error.

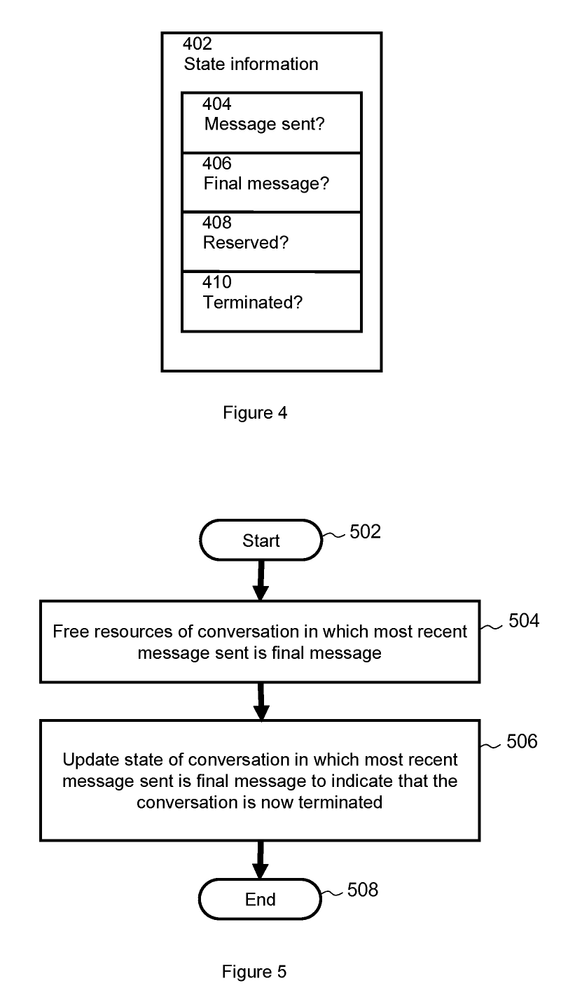

Referring to FIG. 4, state information 402 is maintained in the server computer 204 for each of the plurality of concurrent conversations. State information 402 may contain an indication as to which server task 240-250 it is associated with. State information 402 may consist of an indicator 404 that a message has been sent. This indicates that control has been passed from the server computer 104 to the client computer 102. State information 402 may also consist of an indicator 406 that a final message has been sent from the server computer 104 to the client computer 102. This indicates that the conversation is in the process of being terminated by the server computer 104, but has not yet been terminated. As explained above, in this situation, the client server computer 102 regards the conversation as terminated, but the server computer 104 regards the conversation as still active, although in the process of being terminated. State information 402 may also contain an indicator 408 that a message for a new conversation has been received and that this conversation is reserved for that new conversation. Other indications may also be included in the state information 402. Indicator 404 that a message has been sent may be combined with another indicator or it may be combined with other information such as with which client task 210-220 it is associated. It may also be combined with, for example, a time stamp. Similarly, indicator 406 that this is a final message may be combined with other information such as with which client task 210-220 it is associated. It may also be combined with, for example, a time stamp. Indicator 408 that a message for a new conversation has been received and that this conversation is reserved for that new conversation may also be combined with other information such as with which client task 210-220 it is associated. It may also be combined with, for example, a time stamp. State information 402 may also consist of an indicator 410 that a conversation has been terminated. Termination of a conversation may alternatively be indicated simply by the state information 402 associated with the conversation being deleted.

When a server task 240-250 in the server computer 104 is about to send the final message of a conversation, the indicator 406 in the conversation state 402 associated with the server task 240-250 is updated to indicate that no more messages will be processed for this conversation, that is, that this is the final message of the conversation. The final message is then sent by the server computer 104. At this point in time the server computer 104 assumes that the client computer 102 has received the final message of this conversation but the server computer 104 is not able to determine whether this is the case.

State information similar to that of FIG. 4 is also maintained in the client computer 102. The purposes of the state information maintained in the client computer 102 include enabling the client computer 102 to be aware of how many concurrent conversations there are so that it does not exceed the maximum limit of concurrent conversations. The purposes also include the client computer 102 being aware of the state of any particular conversation 106 so that it can, for example, determine when a conversation has ended. This also helps the client computer 102 to ensure that it does not exceed the maximum limit of concurrent conversations.

Referring to FIG. 5, processing by the server computer 104 continues, starting at step 502. At step 504, in response to the indicator 406 indicating that this is the final message of the conversation, resources in the server computer 104 are freed so as to be available for use by a new conversation. At step 506, once the resources are freed the indicator 410 in the conversation state information 402 is updated to record that the conversation is now terminated. Processing ends at step 508.

In the time between a server task 240-250 sending a final message for a conversation and finally terminating a conversation (steps 504 and 506), another client task 210-220, or the same client task 210-220, can receive the final message of a conversation and can then start a new conversation. This results in the client computer 102 sending the first message of the new conversation to the server computer 104.

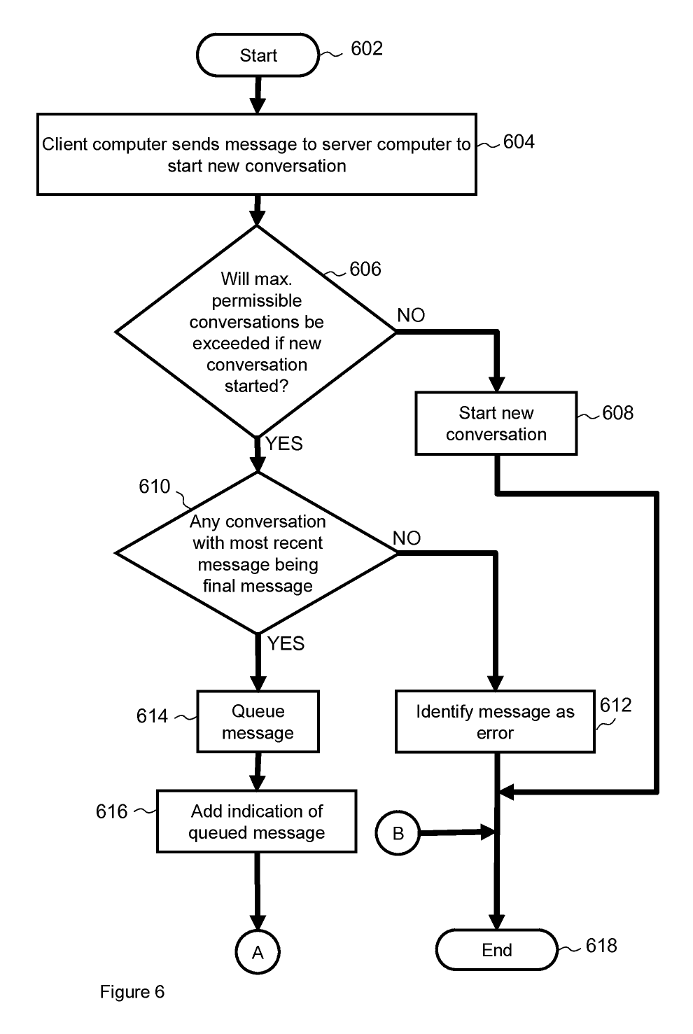

Referring to FIG. 6, processing starts at step 602. At step 604, a client task 210-220 in a client computer 102 sends a message to a server computer 104 to start a new conversation. At step 606, a check is made as to whether the maximum limit for the number of concurrent conversations will be exceeded if the new conversation is started. If the maximum limit for the number of concurrent conversations will not be exceeded, then at step 608 a new conversation is started and the processing ends at step 618.

If the maximum limit for the number of concurrent conversations will be exceeded, then at step 610, the server computer 104 searches for any state information 402 associated with a conversation which records 406 a final message having been sent but which has yet to have resources freed. If no state information 402 associated with a conversation which records 406 a final message having been sent but which has yet to have resources freed is found, then the client computer 102 is attempting to exceed the maximum number of concurrent conversations. This attempt can be regarded as inappropriate and therefore can be treated as an error. At step 612, a message is returned to the client computer 102 indicating that the attempt to start the conversation is an error. Processing then completes at step 618.

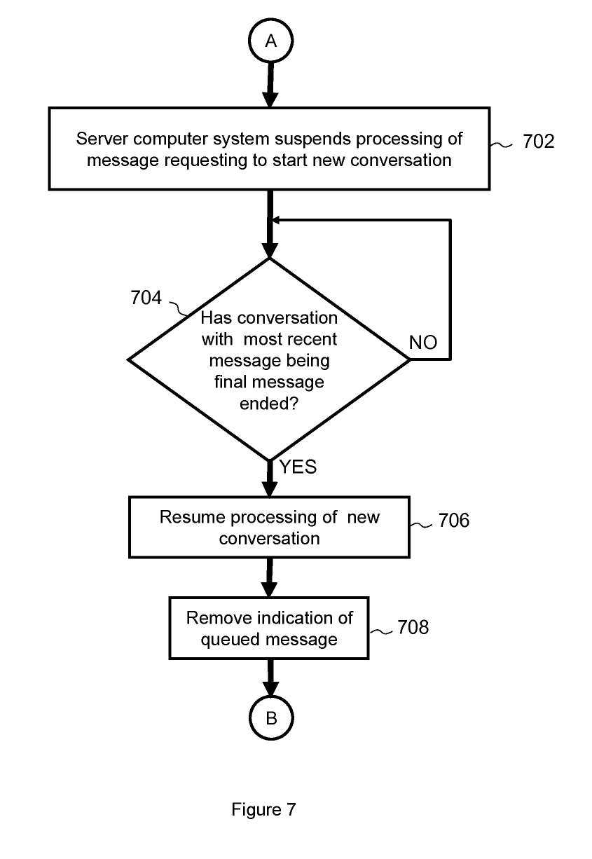

If such an instance of conversation state information 402 is found, then at step 614 the inbound message is queued and at step 616 the conversation state information 402 is updated to record that there is a queued inbound message. This may be by indicating in the state information 402 that the conversation is reserved, for example, by the used of a reserved indicator 408. Processing then continues in FIG. 7.

Referring to FIG. 7, once the inbound message is queued, at step 702, processing of the new conversation is suspended. At step 704, a check is made to determine if the previous conversation is recorded as having ended in the server computer 104, that is has the conversation with the most recent message being a final message ended. This may be made, for example, by checking the terminated indicator 410 in the state information 402. At step 706, when the previous conversation ends, processing of the new conversation is resumed. At step 708, the conversation state information 402 is updated to indicate there is no longer a queued message for a new conversation. Processing then returns to FIG. 6 and ends at step 618.

There is a restriction that conversation state information 402 associated with one of the server tasks 240-250 can only record one inbound message which is queued to start a new conversation. Others of the server tasks 240-250 can each record one inbound message which is queued to start a new conversation.

As described herein, embodiments of the present invention provide a method, system and computer program of managing concurrent conversations over a communications link between a client computer and a server computer, the communications link having a maximum permissible number of concurrent communications, comprising: the client computer and the server computer maintaining state information associated with each of the conversations, the state information including an indication as to whether a message has been sent to the other one of the client computer or the server computer and an indication as to whether the most recent message sent is the final message in the conversation; responsive to a message from a client computer to start a new conversation: the server computer checking whether the maximum permissible number of concurrent conversations will be exceeded if a new conversation is started; responsive to the maximum permissible number of concurrent conversations not being exceeded if a new conversation is started, starting the new conversation; responsive to the maximum permissible number of concurrent conversations being exceeded if a new conversation is started, checking the state information associated with each of the conversations to find a conversation in which the most recent message sent is the final message in the conversation; responsive to not finding state information associated with a conversation in which the most recent message sent is the final message in the conversation, identifying the message from the client computer to start a new conversation as an error and not starting the new conversation; and responsive to finding state information associated with a conversation in which the most recent message sent is the final message in the conversation, adding an indication to the state information indicating that there is a queued message from a client computer to start a new conversation and queuing the message from a client computer to start a new conversation, each state information being associated with a maximum of one queued message. This provides the advantage of allowing the server computer to distinguish between a legitimate peak in the number of requests by a very responsive client computer to start a conversation and an inadvertent attempt by a client computer to overload the server computer.

In one embodiment of the present invention, upon the server computer identifying the message from the client computer to start a new conversation as an error, the server computer sends a message to the client computer indicating that the maximum number of concurrent conversations has been exceeded.

In one embodiment of the present invention, the method, system and computer program further comprises: freeing resources of a conversation in which the most recent message sent is the final message in the conversation; and updating the state information of the conversation in which the most recent message sent is the final message in the conversation to indicate that the conversation is now terminated.

In one embodiment of the present invention, the method, system and computer program carries out the steps of freeing resources and updating the state information in response to the client computer indicating that it has received the final message in the conversation.

In one embodiment of the present invention, responsive to finding state information associated with a conversation in which the most recent message sent is the final message in the conversation and responsive to finding an indication in the state information indicating that there is already a queued message from a client computer to start a new conversation, the method, system and computer program identifies the message from the client computer to start a new conversation as an error and does not start the new conversation.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

It will be equally clear to one of skill in the art that all or part of a logic arrangement according to embodiments of the present invention may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method of managing concurrent conversations over a communications link between a client computer and a server computer, the communications link having a maximum permissible number of concurrent conversations, the method comprising:
maintaining, by the client computer and the server computer, state information associated with a concurrent conversation between the client computer and the server computer, wherein the state information comprises an indication as to whether a message has been sent between the client computer and the server computer, and wherein the state information further comprises an indication as to whether a most recent message sent between the client computer and the server computer is a final message in a conversation;
responsive to the client computer sending a message to the server computer to start a new conversation, the server computer checking whether the maximum permissible number of concurrent conversations will be exceeded if the new conversation is started;
responsive to the maximum permissible number of concurrent conversations not being exceeded if a new conversation is started, starting a new conversation between the client computer and the server computer;
responsive to the maximum permissible number of concurrent conversations being exceeded if a new conversation is started, checking the state information associated with each concurrent conversation between the client computer and the server computer to find a conversation in which a most recent message sent is a final message in a conversation;
responsive to not finding state information associated with a conversation in which a most recent message sent is a final message in a conversation, identifying the message, from the client computer to start the new conversation, as an error, and not starting the new conversation; and
responsive to finding state information associated with a conversation in which a most recent message sent is a final message in the conversation, adding an indication to the state information indicating that there is a queued message from the client computer to start a new conversation, and queuing the queued message from the client computer to start a new conversation, wherein the state information is associated with a maximum of one queued message.

2. The method of claim 1, further comprising:
in response to the server computer identifying the message from the client computer to start a new conversation as an error, the server computer sending a message to the client computer indicating that the maximum permissible number of concurrent conversations has been exceeded.

3. The method of claim 1, further comprising:
freeing resources of a conversation in which a most recent message sent is a final message in the conversation; and
updating the state information of the conversation in which the most recent message sent is the final message in the conversation to indicate that the conversation is now terminated.

4. The method of claim 3, wherein said freeing resources and said updating the state information are carried out in response to the client computer indicating that the client computer has received a final message in the conversation.

5. The method of claim 1, further comprising:
in response to finding state information associated with a conversation in which a most recent message sent is a final message in a conversation, and in response to finding an indication in the state information indicating that there is already a queued message from the client computer to start a new conversation, identifying the message from the client computer to start a new conversation as an error and not starting the new conversation.

6. A system for managing concurrent conversations over a communications link between a client computer and a server computer, the communications link having a maximum permissible number of concurrent conversations, the system comprising:
a client computer, wherein the client computer maintains state information associated with each of conversation being held with a server computer, and wherein the state information comprises:
an indication as to whether a message has been sent to between the client computer and the server computer; and
an indication as to whether a most recent message sent is a final message in a conversation;
a communications link between the client computer and the server computer; and the server computer, wherein the server computer:
responsive to the client computer sending a message to the server computer to start a new conversation, checks whether the maximum permissible number of concurrent conversations will be exceeded if a new conversation is started;
responsive to the maximum permissible number of concurrent conversations not being exceeded if a new conversation is started, starts a new conversation between the client computer and the server computer;
responsive to the maximum permissible number of concurrent conversations being exceeded if a new conversation is started, checks the state information associated with each concurrent conversation between the client computer and the server computer to find a conversation in which a most recent message sent is a final message in a conversation;
responsive to not finding state information associated with a conversation in which a most recent message sent is a final message in a conversation, identifies the message, from the client computer to start the new conversation, as an error, and not starting the new conversation; and
responsive to finding state information associated with a conversation in which a most recent message sent is a final message in the conversation, adds an indication to the state information indicating that there is a queued message from the client computer to start a new conversation, and queuing the queued message from the client computer to start a new conversation, wherein the state information is associated with a maximum of one queued message.

7. The system of claim 6, wherein upon the server computer identifying the message from the client computer to start a new conversation as an error, the server computer sends a message to the client computer indicating that the maximum permissible number of concurrent conversations has been exceeded.

8. The system of claim 6, wherein the server computer frees resources of a conversation in which the state information indicates that a most recent message sent is a final message in a conversation, and wherein the server computer updates the state information of a conversation in which a most recent message sent is a final message in a conversation to indicate that the conversation is now terminated.

9. The system of claim 8, wherein the server computer frees resources and updates the state information in response to the client computer indicating that it has received a final message in a conversation.

10. The system of claim 6, wherein the server computer identifies the message from the client computer to start a new conversation as an error and does not start the new conversation in response to the server computer finding state information associated with a conversation in which a most recent message sent is a final message in a conversation and also finds an indication in the state information indicating that there is already a queued message from a client computer to start a new conversation.

11. A computer program product for managing concurrent conversations over a communications link between a client computer and a server computer, wherein the communications link has a maximum permissible number of concurrent conversations, wherein the computer program product comprises a tangible computer readable storage medium having program code embodied therewith, the program code readable and executable by a processor to perform a method comprising:
maintaining, by the client computer and the server computer, state information associated with a concurrent conversation between the client computer and the server computer, wherein the state information comprises an indication as to whether a message has been sent between the client computer and the server computer, and wherein the state information further comprises an indication as to whether a most recent message sent between the client computer and the server computer is a final message in a conversation;
responsive to the client computer sending a message to the server computer to start a new conversation, the server computer checking whether the maximum permissible number of concurrent conversations will be exceeded if the new conversation is started;
responsive to the maximum permissible number of concurrent conversations not being exceeded if a new conversation is started, starting a new conversation between the client computer and the server computer;
responsive to the maximum permissible number of concurrent conversations being exceeded if a new conversation is started, checking the state information associated with each concurrent conversation between the client computer and the server computer to find a conversation in which a most recent message sent is a final message in a conversation;
responsive to not finding state information associated with a conversation in which a most recent message sent is a final message in a conversation, identifying the message, from the client computer to start the new conversation, as an error, and not starting the new conversation; and
responsive to finding state information associated with a conversation in which a most recent message sent is a final message in the conversation, adding an indication to the state information indicating that there is a queued message from the client computer to start a new conversation and queuing the queued message from the client computer to start a new conversation, wherein the state information is associated with a maximum of one queued message.

12. The computer program product of claim 11, wherein the method further comprises:
in response to the server computer identifying the message from the client computer to start a new conversation as an error, the server computer sending a message to the client computer indicating that the maximum permissible number of concurrent conversations has been exceeded.

13. The computer program product of claim 11, wherein the method further comprises:
freeing resources of a conversation in which a most recent message sent is a final message in the conversation; and
updating the state information of the conversation in which the most recent message sent is the final message in the conversation to indicate that the conversation is now terminated.

14. The computer program product of claim 13, wherein said freeing resources and said updating the state information are carried out in response to the client computer indicating that the client computer has received a final message in the conversation.

15. The computer program product of claim 11, wherein the method further comprises:
in response to finding state information associated with a conversation in which a most recent message sent is a final message in a conversation, and in response to finding an indication in the state information indicating that there is already a queued message from the client computer to start a new conversation, identifying the message from the client computer to start a new conversation as an error and not starting the new conversation.
